(19) United States
(12) Patent Application Publication
(10) Pub. No.: US 2026/0251826 A1
(43) Pub. Date: Aug. 27, 2026

(54) LIGHT DIFFRACTION SYSTEM

(71) Applicant: Ignitor LLC, Cincinnati, OH (US)

(72) Inventor: Keita Taniguchi, Cincinnati, OH (US)

(21) Appl. No.: 19/546,049

(22) Filed: Feb. 20, 2026

Related U.S. Application Data
(60) Provisional application No. 63/761,806, filed on Feb. 21, 2025.

(51) Int. Cl. G02B 5/02; G02B 5/18

(52) U.S. Cl. CPC G02B 5/0278; G02B 5/0221; G02B 5/0236; G02B 5/0294; G02B 5/1866

(57) ABSTRACT

A light diffusion system comprising: a light source configured to emit light; a light diffusion medium configured to receive the light and diffuse the light into an evenly diffused pattern, wherein the light diffusion comprises features and/or textures designed to aid in dispersing the light uniformly as an output light pattern; a control module configured to provide at least one of automated wavelength control, light separation and light incidence angle adjustment.

### RELATED APPLICATION INFORMATION

This application claims priority to U.S. Provisional Patent Application Nos. 63/761,806, entitled “Light Diffraction System,” filed February 21, 2025, and 63/761,813, entitled “Photobioreactor with Light Diffraction System,” also filed February 21, 2025, both of which are incorporated herein by reference as if set forth in full.

### TECHNICAL FIELD

The embodiments described herein are generally directed to light diffraction technology, and, more particularly, to a light diffraction system.

### BACKGROUND

Conventional light diffraction and diffusion systems pose several challenges. Light diffraction systems, while effective in many applications, can present challenges such as a loss of light intensity, difficulty in achieving uniformity in light distribution, potential color distortion, maintenance requirements, costs, and complexity, as well as glare management issues. The diffraction of light often results in a reduction of light intensity, which may be problematic in situations requiring high illumination levels and distribution. Additionally, some diffraction and diffusion materials or techniques can alter the color temperature of light, impacting color fidelity. Furthermore, improper diffraction and diffusion techniques can exacerbate glare issues, diminishing visibility and comfort in certain environments. The diminishment of photon utilization from light in the environment can reduce the efficiency in the use of light energy in photo bioindustries and the artificial lighting industry.

### SUMMARY

In an embodiment, a light diffusion system comprising: a light source configured to emit light; a light diffusion medium configured to receive the light and diffuse the light into an evenly diffused pattern, wherein the light diffusion comprises features and/or textures designed to aid in dispersing the light uniformly as an output light pattern; a control module configured to provide at least one of automated wavelength control, light separation and light incidence angle adjustment.

It should be understood that any of the features in the aspects described above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates an example infrastructure in which one or more of the disclosed processes may be implemented, according to an embodiment;

FIG. 2 is a block diagram illustrating an example wired or wireless system that may be used in connection with various embodiments described herein, according to an embodiment;

FIG. 3 illustrates an example of a system to enhance photon utilization from a light source in the environment, according to an embodiment;

FIG. 4A-4B illustrate an example of a medium with features to incorporated internally disperse light uniformly, according to an embodiment; and

FIG. 5 illustrates a planar light-emitting media, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description. In addition, it should be understood that the various components illustrated herein are not necessarily drawn to scale. In other words, the features disclosed in various embodiments may be implemented using different relative dimensions within and between components than those illustrated in the drawings.

The described technology revolves around a comprehensive system dedicated to manipulating light through structures possessing specific properties and designs. Accordingly, a light diffraction system, which significantly enhances photon utilization from a light source, would leverage a linear or planar (or combination) light diffusing emission medium with a controller. The systems and methods described herein can be used in a range of applications aimed at controlling light transmission, reflection, and diffusion across various mediums such as yarns, fabrics, and planar structures. Further, the present disclosure can employ materials with protrusions or mirror-like surfaces to precisely regulate light behavior. The primary focus lies in controlling light distribution, which can involve elongated and thin light distribution members arranged in specified configurations. The embodiments described herein can use innovative materials and designs to efficiently manipulate light for tasks like photosynthesis, illumination, and other specialized applications for desired outcomes across, e.g., agricultural, architectural, and general lighting purposes. By harnessing the properties of materials and structural arrangements, the core technology provides efficient and targeted control over light to achieve desired results across diverse fields. Furthermore, the systems and methods described herein can incorporate light diffusion and reflection techniques, utilizing components such as transparent diffusion bodies, reflectors, and covers to ensure even light distribution, efficiency, and minimal glare. This system aims to enhance energy efficiency and uniformity in light radiation while adapting diffraction features to suit specific applications and goals.

### 1. System Overview

### 1.1. Infrastructure

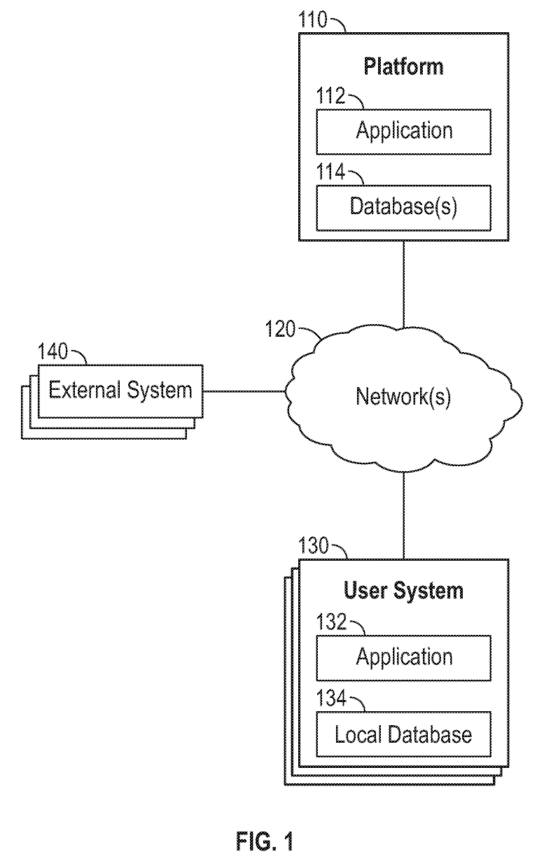

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes (e.g., methods or functions, implemented as software modules) described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes (e.g., methods and functionality), storage, and/or the like, described herein. For example, in such an embodiment, a client application 132, executing on one or more user system(s) 130, may interact with a server application 112 executing on platform 110 to execute one or more or a portion of one or more of the various process(es) described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes (e.g., methods or functions) described herein.

### 1.2. Example Processing Device

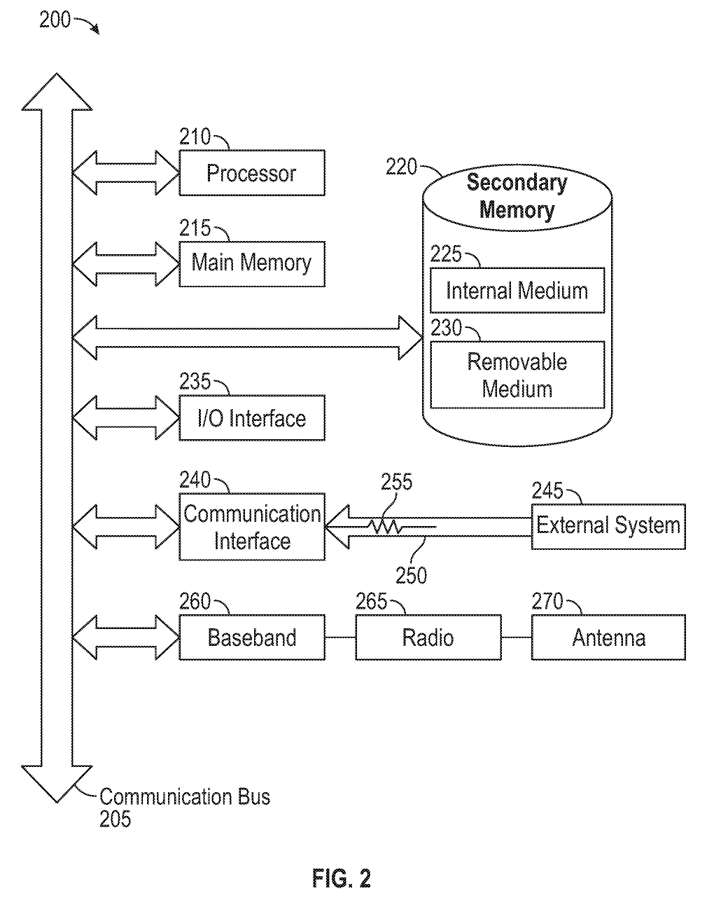

FIG. 2 is a block diagram illustrating an example wired or wireless system 200 that may be used in connection with various embodiments described herein. For example, system 200 may be used as or in conjunction with one or more of the processes (e.g., to store and/or execute the software), including any methods or functions, described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory

(DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various process(es) of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various process(es) of the disclosed embodiments.

### 1.3. General System Design

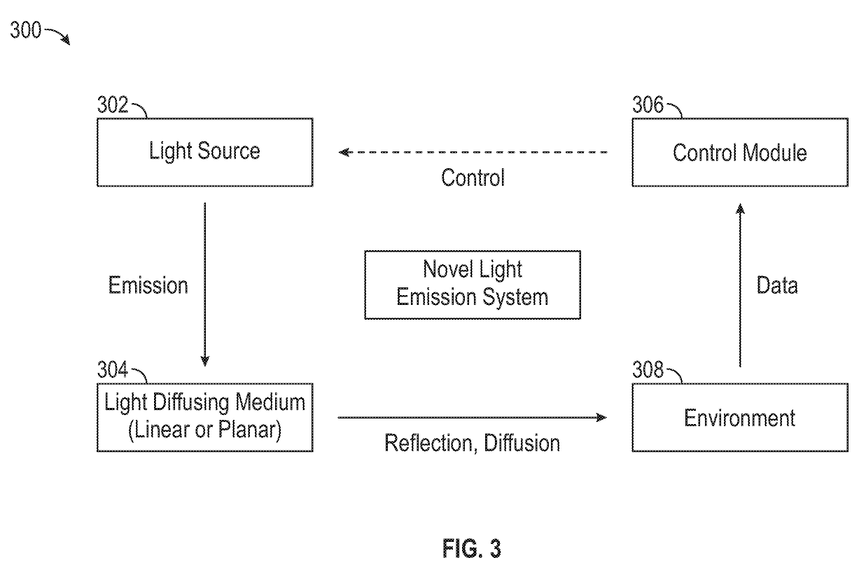

In general, the present disclosure relates to a system 300 that significantly enhances photon utilization from a light source in the environment by leveraging a linear or planar (or combination) light diffusing emission medium 304 with a control device. The light diffraction systems and methods described herein can comprise: a light source 302, a light diffusing medium 304 a controller or control module 306, and an internal environment 308, as illustrated in FIG. 3. Thus control module 306 can be or can be part of a user device 130 and/or platform 110. The light source 302 can include sunlight, artificial light, and/or a hybrid light. The key emphasis is the spectral adjustment function for a hybrid of sunlight and artificial light.

As previously mentioned, a light diffraction system 300 as described herein can employ various types of artificial light sources 302, each offering distinct characteristics suited to specific applications. The artificial light can be generated via plasma lamps, metal halide lamps, Light Emitting Diodes (LEDs), etc. For example, traditional incandescent lamps can be used to generate light by heating a filament, emitting a broad spectrum. Fluorescent lamps, utilizing gas and phosphor coatings, can provide steady and uniform illumination with increased efficiency. LEDs, semiconductor devices emitting light upon current passage, can be also integrated for efficiency and color versatility. Among others light sources, the system can integrate laser sources, halogen lamps, arc lamps, and/or xenon lamps.

In the case of hybrid sunlight and artificial light, sunlight can be used during the day, and artificial light is used as supplementary light during cloudy and rainy weather and evening hours.

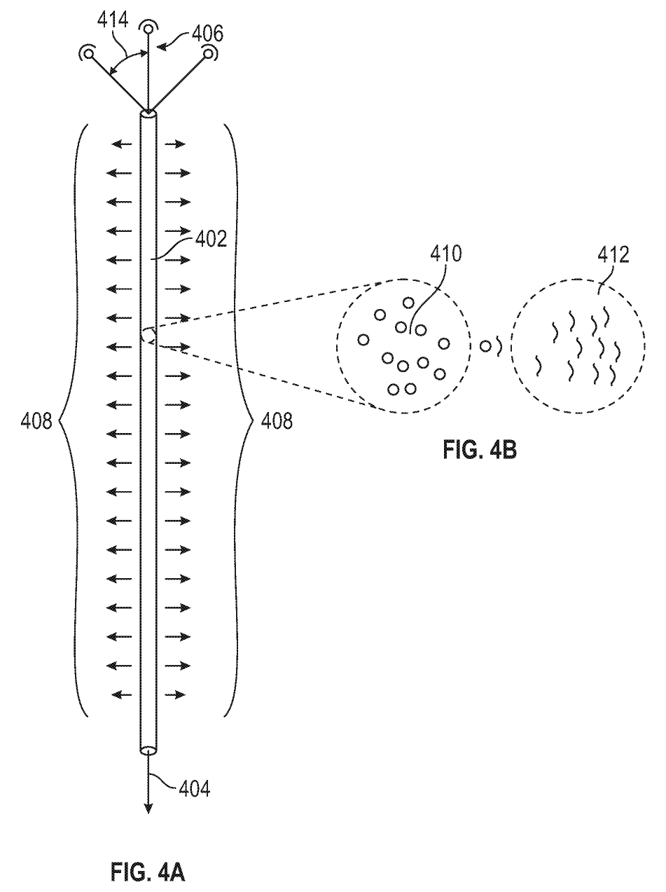

The light diffusing medium 304, can be linear or planar light-emitting medium. A linear light-emitting medium is a medium in which parallel light incident from one end of the medium 402 is emitted evenly as illustrated in FIGS. 4 a. Because it is linear the emission of light follows a straight-line path 404, e.g. down the center of medium 402. Thus, the light rays 406 are all traveling in the same direction along path 404. Further, medium 402 can cause the light to fan out in different directions, creating patterns of constructive and destructive interference. Despite this spreading, light rays 406 overall directionality can still be linear in certain contexts, especially if the diffracting object or aperture is much larger than the wavelength, thereby maintaining a relatively straight path 404 for the majority of the light. Medium 402 will emit the light evenly throughout its length as illustrated by emitted rays 408. Emitted rays 408 can be emitted in different directions, be diffused in a straight line, or different patterns depending on the system’s design. But the light doesn't scatter or disperse irregularly; instead, it spreads uniformly along the medium 402. This property can be useful in various applications such as optical fibers or certain types of lighting systems.

As can be seen in FIGS. 4A and B, medium 402 can have features incorporated internally, such as features 410 and 412 to aid is dispersing the light uniformly. Although, the light can also be dispersed in gradation. In other words, if needed the dispersed light can have more intense regions versus less intense by design, based on how medium 402 is designed.

It should be noted that the light rays 406 from light source 302 can be incident at various angles. In fact, the arrangement and orientation of the light sources can be manipulated in system 300 to achieve certain desired affects. Also, as noted various materials can be used for medium 402 such as glass or plastic. The best performance can be achieved when the diameter of medium 402 is 1 mm or less.

Furthermore, a linear light-emitting medium 402 can serve multiple purposes within a light diffraction or diffusion system as disclosed herein. First, a linear light-emitting medium 402can propagate uniform illumination, distributing light evenly across its surface. This uniformity is essential for achieving consistent and predictable diffraction or diffusion effects. Second, the light-emitting medium 402 can allow controlled directionality of the emitted light. The different designs in the light-emitting medium 402 along with the ability to manipulate the arrangement and orientation of the linear sources 302 to control the angles at which light is diffused or diffracted. Additionally, light sources 402, including using a plurality of sources, e.g., under the control of control module 306, can offer flexibility enabling the creation of visually appealing effects such as gradients, patterns, or animations. Moreover, an expansion of surface area with limited space can be achieved by adding a "twist" structure to a linear light-emitting medium made of plastic, glass, etc.

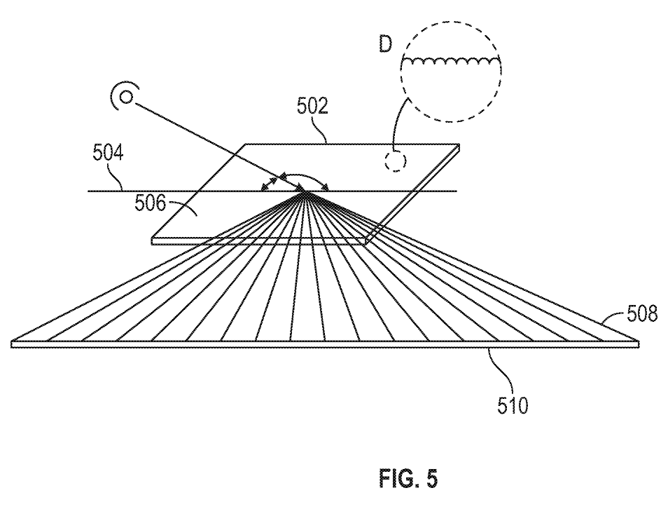

As noted light diffusing medium 304 can also comprise a planar light-emitting media 502 as illustrated in FIG. 5. The planar light-emitting medium 502 can convert striking parallel light 504 incident on a surface 506 into diffracted and/or diffused light 508. The planar light-emitting medium 502 scatters the parallel light rays 406 upon striking surface 506, breaking up their coherence. The planar light-emitting medium 502 can ensure an even distribution of light across its surface 506, eliminating harsh shadows and hotspots, thereby enhancing the overall illumination quality in the light diffraction system 300. Moreover, by converting striking parallel light 504 into diffused light 508, the planar light-emitting medium 502 can contribute to ambient lighting, improving visibility and ambiance in various applications, including architectural lighting. The planar light-emitting medium 502 design can be tailored to achieve the diffusion and/or diffraction desired for a specific application by selecting materials with specific optical properties, offering flexibility in achieving desired lighting outcomes. The planar light-emitting medium 502 can enhance light distribution by effectively scattering incoming light 502, reducing glare, shadows, and ensuring uniform illumination across surfaces 510 in the light diffraction system 300. Moreover, the planar light-emitting medium 502 can contribute to energy efficiency by optimizing light usage.

In certain embodiments, the linear or planar light-emitting media 402/502 can be coated (e.g. thin film) on existing materials such as glass. The incorporation of, e.g., thin films, into light diffraction or diffusion systems, such as system 300, serves to modify the optical properties of existing materials like glass, offering a range of functionalities. Functionally, for example, the planar light-emitting medium 502 can alter the optical behavior of the surface 506 it coats, scattering incoming light rays 406 to achieve desired diffusion or diffraction effects based on factors like thickness, composition, and texture D. Texture D can be applied on the surface, underneath, or both. For instance, texture D might be a fine, grid-like pattern where light diffracts into distinct, closely packed lines or bands, producing a prismatic effect. Additionally, some surfaces might present a soft, undulating pattern of gradients, where light bends and spreads in subtle waves, giving a sense of fluidity and motion; however, these textures D can vary and are not limited to the previously mentioned. The films, when applied to existing materials like glass, can improve light diffusion and/or diffraction, enhancing energy efficiency.

The internal environment 308 can include air, water, internal space, organisms, among others. Various embodiments of system 300 can include different environments and these can vary significantly depending on the light-emitting medium 304 through which light from source 302 propagates. For example, in an environment like water, light behaves differently due to its distinct refractive index compared to air. Factors like suspended particles or impurities in the water influence light scattering, leading to diffraction and/or diffusion effects. The depth and clarity of the water further impact light transmission and dispersion, with deeper or murkier water attenuating light more rapidly. As well, the amount of turbulence can have, such as creating bubbles, can have an advantages or deleterious effect and can or should be controlled, e.g., under the control of control module 306.

In other embodiments, environment 308 can include a vacuum environment, devoid of any matter. In such environments, light propagation follows geometric optics laws, with minimal scattering or diffraction effects.

Optical elements like lenses, prisms, or diffraction gratings (not shown) can be incorporated into a system 300 as well, as can additionally elements such as composite media, comprising multiple materials or phases, can be encountered in certain applications. Engineered materials with tailored optical properties can be used to achieve specific diffraction or diffusion effects.

Control module 306 can be configured to provide automated light wavelength control, a light separation functionality, and/or a light incidence angle adjustment functionality, among other control functions.

Automated light wavelength control can enhance performance by, e.g., allowing for precise adjustment of the light source's 302 spectral characteristics. An automated light wavelength control’s fine-tuning enables optimization of diffraction or diffusion effects by selecting specific wavelengths or combinations thereof. Additionally, automated light wavelength control can adapt the light wavelength dynamically to changing environmental conditions or application preferences, enhancing flexibility and functionality. This adaptability enables, e.g., the creation of dynamic lighting effects, such as color shifting, adding depth and dimension to the light diffraction system's output. Finally, an automated light wavelength control can contribute to energy efficiency by optimizing light wavelength distribution, minimizing waste and operational costs over time.

Control module 306 can also be configured to control light incidence angle adjustment functionality offering an adjustment of the angle at which light is incident on the light diffraction media 402/502. This can allow optimization of light distribution, minimizing areas of shadow or uneven illumination while reducing glare and hotspots. A light incidence angle adjustment functionality can improve the light environment by directing light away from surfaces that cause direct reflection. Additionally, optimized light incidence angles contribute to improved energy efficiency by directing light more effectively towards the target area, reducing energy waste.

Light separation functionality can significantly enhance the capabilities of a light diffraction or diffusion system by providing finer control over the spectral distribution of emitted light. By separating light into its constituent wavelengths, the light diffraction system 300 can improve its efficiency by enabling selective manipulation of specific wavelengths, e.g., via control module 306, reducing energy waste. Additionally, the ability to independently modulate different spectral components can facilitate the creation of dynamic lighting effects, adding light focus to desired illuminated spaces. Furthermore, a light separation functionality can improve light quality by minimizing spectral impurities, resulting in cleaner and more uniform illumination within the light diffraction system 300. For example, an application can involve spectral selective solar collectors, where sunlight is separated into constituent wavelengths to capture specific ranges conducive to efficient energy conversion, thereby maximizing solar energy harvesting efficiency. Additionally, in photovoltaic systems, light separation can optimize spectral response by directing different wavelengths to focused areas, enhancing the overall light diffraction system performance. Moreover, within indoor lighting systems, light separation technology can be utilized to optimize energy efficiency by selectively controlling spectral output and converting excess light energy into electricity or heat, thereby reducing overall energy consumption.

### 2. General Applicability and Functionalities

In general, the present invention provides numerous industrial applications, showcasing its versatility and effectiveness for light diffraction applications. Key examples include its seamless integration in manufacturing processes for enhanced efficiency, its role in optimizing biotechnology devices, and its application in quality control to ensure stringent standards are met. However, it's crucial to note that these instances merely exemplify rather than restrict the breadth of the present invention. It should be understood that the light diffraction system can address diverse industrial needs beyond the highlighted examples below.

The present invention can improve organic material production with photosynthesis. Integrating a light diffraction system as described in this application can significantly enhance organic material production through photosynthesis across various agricultural and environmental applications. Further, light diffraction can scatter light wavelengths and enhance algae and microalgae growth for biofuel or nutrient production. In seedling systems and greenhouses, including wineries, a light diffraction system can improve light distribution, promoting healthier plant growth and accelerated maturation. In mushroom cultivation houses, a light diffraction system can ensure even light exposure for consistent yields. Moreover, in land-based aquaculture and wastewater treatment systems, controlled light diffusion supports phytoplankton growth, improving water quality and ecosystem balance. Even in environments with limited light expose, such as underground shelters and space station CELSS setups, a light diffraction system can aid in simulating optimal light conditions for plant growth. Additionally, its integration into CO₂ fixture devices enhances carbon fixation efficiency, contributing to environmental sustainability and increased agricultural productivity.

Another potential application of the present invention is the enhancement of chemical reactions through the optimization and improvement of conditions such as temperature, pH, and nutrient availability through precise control and monitoring. By using diffraction to focus light in specific wavelengths or intensities, the light diffraction system can influence enzymatic activities and metabolic pathways in microorganisms like yeast. This technology aids in improving fermentation processes by ensuring optimal growth conditions, increasing yield, and maintaining product quality. Among the chemical reactions mentioned, the present invention can effectively distribute Ultraviolet-C (UVC) light across a wider area, ensuring more thorough disinfection and reach corners and surfaces that might be shadowed or difficult to access, thereby improving overall sterilization effectiveness. In air and water sterilization, a diffraction system can help by dispersing UVC light evenly through the medium, ensuring that microorganisms suspended in air or water are exposed to sufficient doses of UVC for effective sterilization. These improvements can be also applied to water recycling processes and systems.

In a more general application, the present invention can improve lighting and increase energy efficiency in various applications. For energy-saving and high-brightness lighting fixtures like interior, road, construction, emergency, and fire truck lighting, the light diffraction system can optimize light distribution, reducing wasted light and directing more brightness where needed. On the other hand, indoor light adjustment benefits from diffraction by enabling precise control over light direction and intensity. In medical settings, especially for surgeries and endoscopes, the diffraction system can ensure uniform and focused illumination. Furthermore, a light diffraction system as disclosed in this application can enhance displays and high-brightness display technology by improving light management and optical efficiency.

Other potential applications for the present invention include sterilization systems for air, water, and mushroom cultivation houses. It also can be applied to water recycling devices, display enhancers with high-brightness capabilities, visible light communication (LiFi) systems for high-speed wireless transmission support, improvement of measurement and sensing with high-sensitivity sensors and enhancing optical fiber performance, and enabling advancements in medical treatments like photodynamic therapy and biotechnological applications. In industrial settings, it can facilitate high-output laser processing, precise stereolithography 3D printing, and efficient control of photochemical reactions. It should be understood that these are only examples of the applications that the present technology can improve, and the previous examples are not limited to the potential applications to other technologies.

Finally, the disclosed invention comprises the following functionalities: a biofilm detection and suppression function, high polymer material, a compactness and parallelization function, a stirring and circulation process, and networking capabilities. These functionalities are interchangeable and independent from each other.

### 3. Industrial Applicability

A light diffraction system finds extensive industrial applicability across various fields such as quality control in industrial manufacturing, biotechnology, and optical instrumentation. The present invention can optimize light diffraction in many applications, such as in an increase in light intensity, achieving uniformity in light distribution, as well as glare management for specific purposes. The utilization of diffraction patterns generated from the interaction of light with the light diffraction system design can adjust parameters like surface roughness, dimensions of microscopic features, and the spectral characteristics of materials for specific applications. In manufacturing, these diffraction patterns can ensure product uniformity and adherence to specifications by accurately measuring critical dimensions and surface qualities. In biotechnology, they can enable uniform light distribution for algae growth and scientific research. Additionally, in optical instrumentation, the present invention can contribute to the development of advanced sensors, imaging technologies, and spectroscopic instruments used in diverse industrial processes ranging from semiconductor fabrication to biomedical diagnostics.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of industrial context or with a particular type of light diffraction system. Hence, although the present embodiments are, for convenience of explanation, depicted and described as being implemented with irrigation systems, it will be appreciated that it can be implemented for various other types of light diffraction systems, and in various other environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed:

1. A light diffusion system comprising:
a light source configured to emit light;
a light diffusion medium configured to receive the light and diffuse the light into an evenly diffused pattern, wherein the light diffusion comprises features and/or textures designed to aid in dispersing the light uniformly as an output light pattern;
a control module configured to provide at least one of automated wavelength control, light separation and light incidence angle adjustment.

2. The system of claim 1, wherein the light source is sunlight.

3. The system of claim 1, wherein the light source is an artificial light source.

4. The system of claim 1, wherein the light source is a hybrid combination of sunlight and an artificial light source, and wherein the control module is configured to provide a spectral adjustment function based to account for the light source and to maintain the desired output light pattern.

5. The system of claim 1, wherein the light diffusion medium is a linear light diffusing medium, and wherein the features and/or textures cause the output light pattern to spread uniformly along a length of the linear light diffusing medium.

6. The system of claim 1, wherein the light diffusion medium is a parallel light diffusing medium.

7. The system of claim 1, wherein the light diffusion medium is made of glass or plastic.

8. The system of claim 1, wherein the light diffusion medium comprises a film applied to a surface of the medium.

9. The system of claim 1, wherein the feature and/or texture comprises features of a dimension configured to diffract the emitted light to create the output light pattern.

10. The system of claim 1, wherein the feature and/or texture comprises features of a dimension configured to diffuse the emitted light to create the output light pattern.

11. The system of claim 1, further comprising an internal environment.

12. The system of claim 1, further comprising an optical element positioned to receive the emitted light after it passes through at least a portion of the light diffusion medium and generate and generate the output light pattern.

13. The system of claim 1, wherein the control module is configured to optimize diffraction or diffusion effects of the output light pattern by selecting specific wavelengths or combinations thereof.

14. The system of claim 1, wherein the control module is configured to control the wavelength of the emitted light to change environmental conditions or application preferences to provide dynamic lighting effects.

15. The system of claim 14, wherein the dynamic lighting effect comprise color shifting.

16. The system of claim 1, wherein the control module is configured to optimize the distribution of the output light pattern minimizing areas of shadow or uneven illumination while reducing glare and hotspots based on data received from an environment.

17. The system of claim 16, herein the control module is configured to adjust a light incidence angle adjustment based on data received from an environment.

18. The system of claim 1, wherein the control module is configure to separate the emitted light into its constituent wavelengths, and provide selective manipulation of specific wavelengths.

19. A light diffraction system comprising:
a light source configured to emit light;
a light diffraction medium configured to receive the light and diffract the light into an evenly diffracted pattern,
wherein the light diffracted medium has a gradation design configured to manipulate the arrangement and orientation of the light to control the angles at which light is diffracted;
a control module configured to manipulate the gradation design; and
an optical element positioned to receive the diffracted pattern and generate an output signal based on the diffracted pattern.

20. The system of claim 19, wherein the light source is sunlight.

21. The system of claim 19, wherein the light source is an artificial light source.

22. The system of claim 19, wherein the light diffraction source is a hybrid combination of sunlight and an artificial light source.

23. The system of claim 19, wherein the light diffraction medium is linear.

24. The system of claim 19, wherein the light diffraction medium emits a parallel light incident from one end of the medium.

25. The system of claim 24, wherein the parallel light incident from one end of the medium is emitted evenly.

26. The system of claim 19, wherein the light diffraction medium is made of glass or
plastic.

27. The system of claim 19, wherein the optical element corresponds to a glass or plastic surface.

28. The system of claim 19, further comprising an internal environment.

29. The system of claim 19, wherein the light is coherent.

30. The system of claim 19, wherein the light is coherent.
